(19) United States
(12) Patent Application Publication
(10) Pub. No.: US 2010/0196487 A1
(43) Pub. Date: Aug. 5, 2010

(54) COMPOSITION WITH ANTIMICROBIAL EFFECT

(75) Inventors: Hans-Jurgen Voss, Vorstetten (DE); Uwe Ferner, Bobbau (DE); Günther Rossa, Dessau-Rosslau (DE)

Correspondence Address: LERNER GREENBERG STEMER LLP, P O BOX 2480, HOLLYWOOD, FL, 33022-2480, US

(73) Assignee: TROVOTECH GMBH, Wolfen (DE)

(21) Appl. No.: 12/677,604

(22) PCT Filed: Aug. 25, 2008
(86) PCT No.: PCT/EP08/06954

§ 371 Date: Mar. 11, 2010

(30) Foreign Application Priority Data
Sep. 12, 2007 (DE) 10 2007 043 311.7

(51) Int. Cl. A01N 25/08; A01N 59/16; A01P 1/00

(52) U.S. Cl. 424/489; 424/618

(57) ABSTRACT

A composition with antimicrobial efficacy has at least one or more polymers; or polymerizable or crosslinkable monomers; or polymerizable or crosslinkable prepolymers; or polymerizable or crosslinkable polymers; and porous glass particles which contain an antimicrobial silver additive.

The invention relates to compositions with antimicrobial effect, at least consisting of one or more polymers; or polymerisable or cross-linkable monomers; or polymerisable or cross-linkable prepolymers; or polymerisable or cross-linkable polymers; and poriferous glass particles which contain a portion of antimicrobial silver admixture.

The antimicrobial properties of silver, copper, or zinc ions have long since been known. Silver ions, for instance, have been used in the form of a silver nitrate solution as disinfectants or antibacterial products.

The use of silver nano-particles is also known, such as it is described in DE 101 46 050 A1 for adhesive and coating materials. Application is however made of metallic silver exposing a very limited quantity of silver ions.

DE 103 59 338 B4 contains a description of an antimicrobial nano-silver additive for polymerisable dental materials, already mentioning that the primary particle diameter of the silver nano-particles is of <40 nm. This can be understood as meaning that the silver nano-particles undergo agglomeration and the distribution in the polymerisable dental material leads to silver aggregates. It is also mentioned that elementary silver has been added.

It has also been common to use silver in easily soluble glasses containing phosphate. U.S. Pat. No. 6,593,260 B2, for instance, describes how to use argentiferous phosphate glasses to equip fibers, yarns and fabrics with antibacterial properties. This is however done by mixing Ag₂O into the glass raw material.

In DE 101 38 568 A1, it is described how to use a phosphosilicate glass in which Ag, Cu or Zn ions are stored, in polyesters. The metal ions are exclusively be liberated by glass dissolution, however.

In DE 101 22 262 A1 polymers with bioactive glass with antimicrobial effect are described, the given compositions of the phosphate glass not containing any silver or zinc however.

The use of glass particles in adhesives, sealing and coating materials is described in WO 2007/054 113 A1 and WO 2007/054 112 A1 respectively, where neither argentiferous glass particles nor an antimicrobial effect is reported, however.

In the patent application “The use of a method for production of antibacterial glasses or glass ceramics”, you will find a description how antimicrobial or antibacterial glass particles of the shape of platelets are manufactured from glass foam. To do so, closed-pore or open-pore glass foams are crushed and then doped by ion-exchange, or open-pore glass foams are doped by ion-exchange prior to crushing. This operation results in glass platelets into whose matrix the silver is bonded, the absorption of silver being limited by the composition of glass. The silver ions can only be liberated by the dissolution of glass particles or by diffusion in low concentration.

All the foregoing solutions have the disadvantages below:
a) The silver is not liberated earlier than when the glass particles being dissolved in antimicrobially efficient concentrations;
b) the silver exists in a metallurgic form, in nano-particles, or in bound form in the glass matrix, and silver ions can only be liberated in low concentrations in accordance with the solution balance; and
c) the silver nano-particles will agglomerate so that the specific surface area is reduced, and the dissolution of silver ions is reduced, too.

It is the purpose of the present invention to find antimicrobially equipped compositions from polymers, polymerisable or cross-linkable monomers, prepolymers or polymers on the basis of silver, which prevent the growth of bacterial, fungi, yeasts and lichens over longer periods of time. It is also intended to find a procedure to produce such a composition.

The purpose of the invention is fulfilled with the characteristics of Claim 1.

One essential feature of the invention is that the silver exists in a minimum weight percentage of 40 to 100 in ionic form in the poriferous glass particles which are obtained by continually foaming the glass, that these poriferous glass particles are the result of foaming glass types containing alkaline earths, and that the density of the glass matrix of these glass types containing alkaline earths is between 1.0 and 2.0 g/cm³ and the diameters of pores where the metal ions are to be stored range from 1.0×10−¹⁰ m to 20×10−¹⁰ m.

It was found that very small poriferous glass particles, which are generated from glass foam and then doped with silver salts, preferably silver nitrate, can excellently be mixed into polymers, polymerisable or cross-linkable monomers, prepolymers or polymers without the glass particles agglomerating, thus increasingly liberating the silver ions stored in the poriferous glass particles which in turn results in a protection against microbial attacks against the composition.

A number of advantageous embodiments of the compositions of the intention are presented in the Claims 2 through 15 without limiting the invention to those examples, however.

The purpose of the invention is also fulfilled by a procedure in accordance with Claim 18.

One essential feature of the invention is that the poriferous glass particles can be obtained by crushing the glass foam made from glass types containing alkaline earths, and then doping it with silver from silver salt solutions.

You can obtain poriferous glass particles from glass foams produced by continuous procedures, for instance. To do so, as any expert will know, you melt conventional glass raw materials or glass shards, mixing them with a blowing agent under pressure. If you cool the glass foam down very fast at the extruder exit you will obtain glass foams made of poriferous glass.

Such conventional glass raw materials or glass shards may consist of glasses containing alkaline earths, in particular of silicate or borosilicate glasses. The microstructure density of the glass matrix of such glasses, which are as poriferous as meant in the invention, are between 1.0 and 2.0 g/cm³, preferably between 1.3 and 1.6 g/cm³. The pore diameters here relevant are 1.0×10−¹⁰ m up to 20×10−¹⁰ m, i.e. 1 to 20 Angstrom.

The very small poriferous glass particles produced by crushing the glass foam, with an average particle size of 1 to 50 um, preferably 2 to 6 μm, are mixed afterwards with a dissolved silver salt, preferably silver nitrate solution. You add, referred to the glass particles, a quantity of 1 to 15 weight per cent, preferably 4 to 7 weight per cent of silver salt solution. The porosity of the glass particles will allow for the absorption of the silver solution by the glass particles, the latter not clotting together.

A subsequent tempering/drying process has the purpose to partly fix the silver ions to the pore walls of the glass particles by ion bonding, and to reduce the humidity content of the silver-containing poriferous glass particles. The silver content of the poriferous glass particles should range between 0.1 and 10 weight per cent, preferably 0.5 and 5 weight per cent.

A quantity of 40 to 100 weight per cent, preferably 60 to 80 weight per cent of the silver mixed in is present in the poriferous glass as silver ions. The remaining silver exists in the pores in a metal form, referring to 100 weight per cent.

The dried poriferous glass particles, now containing silver, are mixed into polymers, polymerisable or cross-linkable monomers, prepolymers or polymers in the well known way. A quantity of 0.1 to 30 weight per cent, preferably 0.5 to 2.0 weight per cent of the argentiferous poriferous glass particles are mixed into the polymers, polymerisable or cross-linkable monomers, prepolymers or polymers.

Due to the fact that the silver ions are located in the poriferous glass particles, they will not be peeled off if they are, for instance, mixed into a polymer of high viscosity, such as by a kneading process.

The fact that the prevailing content of the silver, namely a content of 40 to 100 weight per cent, is present in the poriferous glass particles in their ionic form, larger quantities of silver ions can be liberated in products made from polymers, polymerisable or cross-linkable monomers, prepolymers or polymers, thus becoming active with their antimicrobial properties on the surface.

So, according to the invention, no additional antimicrobial component is needed during the start-up stage.

The improved liberation of silver ions can be described using the following comparison:

Take 0.1 g of an argentiferous, antimicrobial product and elute it in 100 ml distilled water for 24 hours. Whereas in other antimicrobial products, 1 to 35 pg are analysed in the eluate, the silver content of the eluate of the poriferous argentiferous glass powder is 100 to 400, preferably 170 to 270 μg/L.

The glass raw materials or glass shards used here can contain 1 to 15 weight per cent, preferably 1 to 5 weight per cent of zinc white in a special embodiment of the invention.

Below follows an explanation of the polymers, polymerisable or cross-linkable monomers, prepolymers or polymers, into which the antimicrobial, poriferous glass particles are mixed in accordance with the invention.

The polymers, polymerisable or cross-linkable monomers, prepolymers or polymers, are frequently used as binders in recipes for adhesive, sealing and coating agents.

But they can also be processed to become molded parts, foils or fibers. The compositions may contain further fillers or functional fillers. In this case, the term functional fillers is to be understood as agents including flame retardants, reinforcing agents, emulsifiers, slip additives, dyestuff, pigments, brighteners, nucleating agents, polyamide stabilizers, antioxidants, silanes, ultraviolet light absorbers, blowing agents and antistatic agents.

Cross-linkable monomers may be two-cyanoacrylic esters, which, in this case, are so-called cyanacrylate adhesives. The latter are single-component adhesives on the basis of monomeric 2-5-cyanoacrylic esters.

They can also be polyurethanes on the basis of at least one polyisocyanate and at least one polyol and/or polyamine. They are suited for the production of glues and molding compounds. The molding compounds may be concrete, or foams if they contain an additional blowing agent. The binders may be single-component or two-component polyurethane binders.

They could furthermore be two-component polyurethane binders which mainly comprise one reaction product of at least one polyol or polyamine with at least one polyisocyanate, then you would have to add, as a blowing agent, at least one carboxylic acid and water, as far as needed, to produce the pores and thus foam materials. Instead of polyols, or polyamins and carboxylic acids, you could also use hydroxy acids or amino acids with a functionality being even larger than 1.

It is also possible to take prepolymers, i.e. oligomers with more than one isocyanate groups, which you can obtain, as is already well known, due to a large excess of monomeric polyisocyanates in the presence of diols, for instance.

Dispersions on the basis of polyvinyl acetate, polyacrylate, polybutadiene styrene, polyvinylides, polyurethane, polychloroprene, caoutchouc, vinylacetate acrylate copolymers, maleinates or polyolefines. These compositions can be used as so-called dispersion adhesives.

Hot melts, which are preferably taken from a group comprising pressure-sensitive adhesives, polyolefines, ethylene vinyl acetate copolymers, polyamides, polyurethanes, silane-terminated polyurethanes, and silane-terminated polyamides.

Epoxy resins, which may include standard epoxy resins combined with conventional hardeners, such as polyamines. Compositions may also contain modified epoxy resins or special further additives. They can even be reactive hot melts on the basis of epoxy resins.

Silicones, silane hardening polymers, modified silicones (MS polymers), polysulfides, polyurethanes, caoutchouc, polyacrylates, dispersion sealants, polyvinyl chloride and/or other plastisols as binders in sealing compounds.

Compositions made of silicone caoutchouc vulcanising at ambient temperatures for sealing compounds which are composed of a polyorganosiloxane base polymer with a silanol end group, a cross-linking agent composed of alkyl acyloxy silanes and/or siloxanes and some particle-like filler.

Single-component molding and sealing compounds on the basis of prepolymers which contain silyl end groups with at least one hydrolysable substituent on the Si atom.

Adhesive, sealing or coating substances which contain as binder a polymer which corresponds to the general formula below:

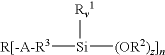

where R is an organic matrix,

A means a carboxy, carbamat, carbonate, ureido, urethane, or

sulfonate bond or an oxygen atom,

R¹ an alkyl residue with 1 up to 4 C atoms or OR²,

R² an alkyl residue with 1 up to 4 C atoms or an acrylic residue with 1 up to 4 C atoms,

R³ a straight-chain or ramified, substituted or unsubstituted alkylene residue with 1 up to 8 C atoms,

v=is from 0 to 2,

z=3−v, and

n=1 up to 10000,

the silyl residues being equal or different, and, in the case of several residues R¹ or R², each of them being possibly equal or different.

The organic matrix is advantageously selected from the group including alkyd resins, oil-modified alkyd resins, unsaturated polyesters, natural oils such as linseed oil, tung oil, soy bean oil as well as epoxides, polyamides, thermoplastic polyesters such as polyethylene terephthalate and polybutylene terephthalate, polycarbonates, polyethylenes, polybutylenes, polystyrenes, polypropylenes, ethylene propylene co- and terpolymers, acrylates such as homo- and copolymers of acrylic acid, acrylates, methacrylates, acrylamides, their salts and similar, phenolic resins, polyoxymethylene homo- and -copolymers, polyurethanes, polysulfones, polysulfide caoutchoucs, nitrocellulose, vinyl butyrates, vinyl polymers, such as vinyl polymers containing vinyl chloride and/or vinyl acetate, ethyl cellulose, cellulose acetates and cellulose butyrates, rayon, lacca, waxes, ethylene copolymers such as ethylene vinyl acetate copolymers, ethylene acrylic acid copolymers, ethylene acrylate copolymers, organic caoutchoucs, silicone resins and similar.

Further examples include polyethers such as polyethylene oxide, polypropylene oxide and polytetrahydrofurane, polyol, poly(meth)acrylate, polyvinyl alcohol. From among the named polymer matrices, special preference is put on polyethers, polyesters, polyurethanes and polyols.

Physically binding adhesive, sealing and coating substances, meaning substances such as dispersion adhesives, solvent adhesives, and hot melts. Generally, dispersion adhesives are produced by combining polymeric dispersions, such as polyvinyl acetate dispersions and polyacrylate dispersions.

A preferred composition comprises an aqueous dispersion of copolymers of styrene or alpha-methylstyrene with dienes or acrylic derivates from among the group of styrene-butadiene, styrene-acryinitril, styrene-alkyl methacrylate, styrene butadiene alkyl acrylate and methacrylate, styrene maleic acid anhydride, styrene acrylnitril methyl acrylate; mixtures of high impact resistance made of styrene copolymers and another polymer such as a polyacrylate, a diene polymer, or an ethylene-propylene-dien-terpolymer; as well as block-copolymers of styrene such as styrene-butadiene-styrene (SBS), styrene isoprene styrene, styrene ethylene/butylene styrene or styrene ethylene/propylene styrene.

Aquaeous emulsion of natural or synthetic caoutchoucs, such as natural rubber latex or latices made of carboxylated styrene butadiene copolymers.

Polymers derived from alpha, beta-unsaturated acids and their derivates, such as polyacrylates and polymethacrylates, polyacrylamides and polyacryl nitriles.

Halogenated polymers, such as polychloroproprene, chlorinated rubber, chlorinated or chlorosulfonated polyethylene, copolymers of ethylene and chlorinated ethylene, epichlorhydrine homo- and copolymers, in particular polymers from halogenated vinyl compositions, such as polyvinyl chloride, polyvinylidene chloride, polyvinyl fluoride, polyvinylidene fluoride; as well as their copolymers, such as vinyl chloride-vinylidene chloride, vinyl chloride-vinylacetate or vinylidene chloride vinylacetate.

Polymers, polymerisable or cross-linkable monomers, prepolymers or polymers from the group in which you find polyethylene, polypropylene, acrylnitrile butadiene styrene copolymer, styrene acrylnitrile copolymer, polystyrene, polymethyl methacrylate, polyethylene terephthalate, polyamide, polyvinyl chloride, polymer latex, polyurethane, thermoplastic polyurethane, urea-formaldehyde resin, phenolic resins and unsaturated polyester.

You may mix additives from the group in which you find flame retardants, reinforcing agents, emulsifiers, slip additives, dyestuff, pigments, brighteners, nucleating agents, polyamide stabilizers, antioxidants, silanes, ultraviolet light absorbers, blowing agents and antistatic agents to the polymers, polymerisable or cross-linkable monomers, prepolymers or polymers.

1-20. (canceled)

21. An antimicrobial composition, comprising:
one of more components selected from the group consisting of one or more polymers; polymerizable or cross-linkable monomers; polymerizable or cross-linkable prepolymers; and polymerizable or cross-linkable polymers;
porous glass particles formed by continually foaming glass, said porous glass particles consisting of glass foam of alkaline earths-containing glass;
said alkaline earths-containing glass having a glass matrix with a density between 1.0 and 2.0 g/cm³ and having pores formed therein with diameters ranging from 1.0×10⁻¹⁰ m to 20×10⁻¹⁰ m; and
an antimicrobial admixture of silver ions and silver nano-particles in said pores of said glass particles, said silver existing at a minimum of 40 to 100 percent by weight in ionic form in said porous glass particles.

22. The composition according to claim 21, which comprises 2-cyanoacrylic esters as cross-linked monomers.

23. The composition according to claim 21, which further comprises polyurethane binders based on at least one polyisocyanate and at least one polyol and/or polyamine.

24. The composition according to claim 21, which further comprises dispersions on a basis of polyvinyl acetate, polyacrylate, polybutadiene styrene, polyvinylides, polyurethane, polychloroprene, caoutchouc, vinylacetate acrylate copolymers, maleinates or polyolefines.

25. The composition according to claim 21, wherein the composition is a hot melt on a basis of olefines, ethylene vinyl acetate copolymers, polyamides, polyurethanes, silane-terminated polyurethanes, and silane-terminated polyamides.

26. The composition according to claim 21, which further comprises at least one of epoxy resins, silicones, silane hardening polymers, modified silicones, polysulfides, caoutchouc, polyacrylates, dispersion sealants, and/or other plastisols.

27. The composition according to claim 21, wherein the metal ions used for storing are silver ions.

28. The composition according to claim 21, wherein the glass of said glass particles is a silicate glass or a borosilicate glass and said porous glass particles have a silver content between 0.1 and 10% by weight.

29. The composition according to claim 28, wherein the silver content lies between 0.5 and 5.0% by weight.

30. The composition according to claim 21, wherein said porous glass particles include from 0.1 to 30% by weight porous, argentiferous glass particles from silicate or borosilicate glasses.

31. The composition according to claim 30, wherein said silicate or borosilicate glasses amount from 0.5 to 2.0% by weight.

32. The composition according to claim 21, which comprises foamed silicate or borosilicate glass containing heavy metal oxides at a proportion of up to 30% by weight.

33. The composition according to claim 32, wherein the proportion of said heavy metal oxides lies between 5 and 20% by weight.

34. The composition according to claim 32, wherein said heavy metal oxides are selected from the group consisting of zinc white and copper oxide.

35. The composition according to claim 21, which further comprises argentiferous porous glass particles from silicate or borosilicate glasses, and one or more further fillers.

36. The composition according to claim 21, which comprises further additives.

37. The composition according to claim 36, wherein said further additives are selected from the group consisting of flame retardants, reinforcing agents, emulsifiers, slip additives, dyestuff, pigments, brighteners, nucleating agents, polyamide stabilizers, antioxidants, silanes, ultraviolet light absorbers, blowing agents, and antistatic agents.

38. The composition according to claim 21, wherein said polymers, polymerizable or cross-linkable monomers, prepolymers or polymers are selected from the group consisting of polyethylene, polypropylene, acrylnitrile butadiene styrene copolymer, styrene acrylnitrile copolymer, polystyrene, polymethyl methacrylate, polyethylene terephthalate, polyamide, polyvinyl chloride, polymer latex, urea-formaldehyde resin, phenolic resins, and unsaturated polyesters.

39. The composition according to claim 21, which comprises porous glass particles from silicate or borosilicate glasses obtained by crushing glass foam and then doping the preparation with silver from silver salt solutions, by mixing the porous glass particles with dissolved silver salts, and afterwards drying the mixture.

40. The composition according to claim 39, which comprises mixing the glass particles with silver salts in the form of silver nitrate,

41. The composition according to claim 21 configured as a binder in an adhesive, a sealing material, or a coating material.

42. The composition according to claim 21 configured as a basic material for antimicrobial molding parts, foils, or fibers.

43. A method of producing the composition according to claim 21, which comprises:
foaming alkaline earths-containing glass to form a foam;
crushing the foam to obtain porous glass particles; and
subsequently doping the glass particles with silver from a silver salt solution to form the composition of claim 21.

44. The method according to claim 43, wherein the silver salt solution is dissolved silver nitrate.

45. The method according to claim 43, which comprises foaming silicate or borosilicate glasses.

46. The method according to claim 43, which comprises producing the glass particles by foaming and crushing glasses containing alkaline earths to form a porous glass powder with glass particles having a density of 1.0 to 2.0 g/cm³, mixing the porous glass powder with dissolved silver salts, and subsequently drying the mixture.

47. The method according to claim 46, which comprises forming the glass with a density of 1.3 to 1.6 g/cm³ and mixing the glass powder with silver nitrate.

48. The method according to claim 46, wherein the glass types containing alkaline earths are silicate or borosilicate glasses.
